(19) United States
(12) Patent Application Publication
(10) Pub. No.: US 2008/0027184 A1
(43) Pub. Date: Jan. 31, 2008

(54) CLEANING BLADE MEMBER

(75) Inventors: Miyuki UENO, Shinagawa-ku (JP); Shuji ABE, Shinagawa-ku (JP); Shuhei NODA, Shinagawa-ku (JP)

Correspondence Address: SUGHRUE MION, PLLC, 2100 PENNSYLVANIA AVENUE, N.W., SUITE 800, WASHINGTON, DC, 20037, US

(73) Assignee: SYNZTEC CO., LTD., Tokyo (JP)

(21) Appl. No.: 11/828,786

(22) Filed: Jul. 26, 2007

(30) Foreign Application Priority Data
Jul. 27, 2006 (JP) 2006-205367
Jul. 18, 2007 (JP) 2007-187482

(51) Int. Cl. C08L 75/04

(52) U.S. Cl. 525/459

(57) ABSTRACT

The present invention provides a cleaning blade member which can be excellently produced by molding and which exhibits small variation in physical properties with temperature, and excellent wear resistance. The cleaning blade member formed of a castable polyurethane member produced through hardening and molding a polyurethane composition containing at least a polyol, a polyisocyanate, and a diamino compound, wherein the diamino compound has a melting point of 80° C. or lower, the polyisocyanate is a blend of 4,4′-diphenylmethane diisocyanate (MDI) and 3,3-dimethylphenyl-4,4-diisocyanate (TODI), and the ratio of TODI in the entirety of polyisocyanate is 30 to 100% by weight.

The entire disclosure of Japanese Patent Applications Nos. 2006-205367 filed Jul. 27, 2006 and 2007-187482 filed Jul. 18, 2007 is expressly incorporated by reference herein.

### BACKGROUND OF THE INVENTION

1. Field of the Invention

The present invention relates to a cleaning blade member and, more particularly, to a cleaning blade member for removing toner deposited on a toner image carrier employed in an electrophotographic process such as a photoconductor or a transfer belt, on which a toner image is formed and which transfers the formed image to an image receptor.

2. Background Art

Generally, in an electrophotographic process, electrophotographic apparatus parts such as an electrophotographic photoreceptor and a transfer belt are used cyclically and repeatedly, and toner deposited thereon is removed by means of a cleaning blade. The cleaning blade, which generally comes into contact with a photoreceptor over a long period of time, is required to have excellent wear resistance. Currently, members for use in such a cleaning blade are made of polyurethane. Polyurethane is employed because it has excellent wear resistance, exhibits sufficient mechanical strength without incorporation of additives such as a reinforcing agent thereinto, and does not stain objects. However, polyurethane has a drawback in that physical properties thereof, in particular rebound resilience, vary with temperature. Such variation in rebound resilience is problematic, when a cleaning blade made of polyurethane is employed.

Japanese Patent Application Laid-Open (kokai) No. 2003-076241 discloses that a urethane-urea member for use in office automation (OA) devices, which has been formed from a urethane-urea-imide composition containing a mixture of an isocyanate compound and an imide-modified isocyanate compound, a polyol, and a diamino compound, can be employed in a cleaning blade.

Japanese Patent No. 3,666,331 discloses that a cleaning blade is produced by hardening a polyurethane composition containing a polyisocyanate, a polyol, and a diamino compound (2,2′,3,3′-tetrachloro-4,4′-diaminodiphenylmethane), in order to enhance wear resistance and chipping resistance at high temperature.

However, since the rate of reaction of the diamino compound (2,2′,3,3′-tetrachloro-4,4′-diaminodiphenylmethane) employed in the compositions disclosed in the patent documents is excessively high, formation of sheets of the compositions is problematically impeded.

Therefore, there is demand for a cleaning blade which can be excellently molded, whose physical properties are minimally affected by temperature, and which exhibits excellent wear resistance.

### SUMMARY OF THE INVENTION

In view of the foregoing, an object of the present invention is to provide a cleaning blade member which can be excellently produced by molding and which exhibits small variation in physical properties with temperature, and excellent wear resistance.

A first mode of the present invention for attaining the aforementioned object provides a cleaning blade member formed of a castable polyurethane member produced through hardening and molding a polyurethane composition containing at least a polyol, a polyisocyanate, and a diamino compound, wherein the diamino compound has a melting point of 80° C. or lower, the polyisocyanate is a blend of 4,4′-diphenylmethane diisocyanate (MDI) and 3,3-dimethylphenyl-4,4-diisocyanate (TODI), and the ratio of TODI in the entirety of polyisocyanate is 30 to 100% by weight.

A second mode of the present invention is drawn to a specific embodiment of the cleaning blade member of the first mode, wherein the diamino compound contains no chlorine atom but contains an aromatic ring in the molecular structure thereof and exhibits a reaction rate slower than that of 2,2′,3,3′-tetrachloro-4,4′-diaminodiphenylmethane under given hardening and molding conditions.

A third mode of the present invention is drawn to a specific embodiment of the cleaning blade member of the first or second mode, wherein the polyurethane member exhibits a ΔRb (%) of 40 or less, ΔRb (%) being represented by the following formula:

ΔRb (%)=Rb_{T50}−Rb_{T10}

wherein Rb_{T10} and Rb_{T50} represent rebound resilience at 10° C. and that at 50° C., respectively.

A fourth mode of the present invention is drawn to a specific embodiment of the cleaning blade member of any of the first to third modes, wherein the polyurethane member exhibits an elongation at break of 300% or more.

A fifth mode of the present invention is drawn to a specific embodiment of the cleaning blade member of any of the first to fourth modes, wherein the polyurethane member exhibits a tan δ (1 Hz) peak temperature of 10° C. or lower.

According to the present invention, a diamino compound is incorporated into a polyurethane composition containing a blend of MDI and TODI serving as a polyisocyanate component. Thus, the composition exhibits excellent moldability, and a cleaning blade member which exhibits small variation in physical properties with temperature and excellent wear resistance can be provided from the polyurethane composition.

### DETAILED DESCRIPTION OF PREFERRED EMBODIMENTS

The present invention is directed to a cleaning blade member formed of a castable polyurethane member produced through hardening and molding a polyurethane composition containing at least a polyol, a polyisocyanate, and a diamino compound, wherein the diamino compound has a melting point of 80° C. or lower, the polyisocyanate is a blend of 4,4′-diphenylmethane diisocyanate (MDI) and 3,3-dimethylphenyl-4,4-diisocyanate (TODI), and the ratio of TODI in the entirety of polyisocyanate is 30 to 100% by weight. The cleaning blade of the present invention can be excellently produced by molding and exhibits small variation in physical properties with temperature, and excellent wear resistance.

In other words, by virtue of a diamino compound having a melting point of 80° C. or lower, the cleaning blade member of the present invention maintains excellent mechanical characteristics also at low temperature and mitigates variation of rebound resilience with temperature. Through use in combination of 4,4′-diphenylmethane diisocyanate (MDI) and 3,3-dimethylphenyl-4,4-diisocyanate (TODI) as the polyisocyanate, the cleaning blade of the invention can be excellently produced by molding. Furthermore, through use in combination of a diamino compound and 3,3-dimethylphenyl-4,4-diisocyanate (TODI), the cleaning blade member exhibits high hardness and high rebound resilience.

The diamino compound employed in the invention has a melting point of 80° C. or lower. This is important because, for proceeding a reaction, the composition containing the diamino compound must be heated to a temperature equal to or higher than the melting point of the diamino compound, and if the reaction temperature is 80° C. or higher, pot life of the reaction system is considerably shortened. When the pot life of the composition is shortened, the composition cannot be molded or dimensional precision of the molded products is impaired. As used herein, the term “pot life” refers to a period of time when the relevant material has comparatively low viscosity and maintains fluidity.

In addition, preferably, the diamino compound contains no chlorine atom but contains an aromatic ring in the molecular structure thereof and exhibits a reaction rate slower than that of 2,2′,3,3′-tetrachloro-4,4′-diaminodiphenylmethane under given hardening and molding conditions. Since the diamino compound contains no chlorine atom, the compound has substantially no steric hindrance, whereas since the compound has an aromatic ring, polyurethane hardened with the diamino compound exhibits small variation in physical properties with temperature, excellent mechanical strength, and excellent wear resistance. When the diamino compound exhibiting a reaction rate slower than that of 2,2′,3,3′-tetrachloro-4,4′-diaminodiphenylmethane is employed in production of polyurethane, failure of sheet formation due to excessively fast reaction rate can be prevented.

Among diamino compounds, at room temperature, some assume a liquid form and others assume a solid form. Of these, liquid-form diamino compounds are preferred. Examples of the diamino compound satisfying the conditions include diaminodiphenylmethane compounds and phenylenediamine compounds. Specific examples include 4,4′-methylenedianiline (DDM), 3,5-dimethylthio-2,4-toluenediamine (DMTDA), 2,4-toluenediamine (2,4-TDA), 2,6-toluenediamine (2,6-TDA), methylenebis(2-ethyl-6-methylamine), 1,4-di-sec-butylaminobenzene, 4,4-di-sec-butylaminediphenylmethane, 1,4-bis(2-aminophenyl)thiomethane, diethyltoluenediamine, trimethylenebis(4-aminobenzoate), and polytetramethylene oxide di-p-aminobenzoate.

Examples of the polyol include polyester-polyols (produced through dehydration condensation between diol and dibasic acid), polycarbonate-polyols (produced through reaction between diol and alkyl carbonate), caprolactone-type polyols, and polyether-polyols. The polyol content of the polyurethane is preferably 60 to 80% by weight. When the polyol content of the polyurethane falls within the range, the cleaning blade member can obtain the excellent mechanical characteristics.

The polyisocyanate employed in the present invention is a blend of 4,4′-diphenylmethane diisocyanate (MDI) and 3,3-dimethylphenyl-4,4-diisocyanate (TODI), and ratio of TODI in the entirety of polyisocyanate is adjusted to 30 to 100% by weight. As mentioned above, when 4,4′-diphenylmethane diisocyanate (MDI) and 3,3-dimethylphenyl-4,4-diisocyanate (TODI) are used in combination as the polyisocyanate, a cleaning blade can be excellently produced by molding. When the ratio of 3,3-dimethylphenyl-4,4-diisocyanate (TODI) in the entirety of polyisocyanate is lower than 30% by weight, reaction with the aforementioned diamino compound for producing polyurethane members proceeds at an excessively high rate, resulting in molding failure.

The polyisocyanate content is preferably 25 to 70% by weight in the entirety of polyurethane. When the polyisocyanate content is less than 25% by weight, tensile strength may be poor, whereas when the content is in excess of 70% by weight, permanent elongation increases excessively. Both cases are not preferred.

In the present invention, the diamino compound is employed as a cross-linking agent. In addition to the diamino compound, short-chain diols and/or short-chain triols may be used. No particular limitation is imposed on the type of short-chain diols, and propanediol (PD), butanediol (BD), etc. may be used. Two or more of the diamino compound (bi-functional cross-linking agent) and the short-chain diols (bi-functional cross-linking agent) may each be mixed.

No particular limitation is imposed on the type of short-chain triols, and a triol having a molecular weight of 120 to 4,000 is preferred, with a triol having a molecular weight of 120 to 1,000 being more preferred. Specific examples include short-chain triols such as trimethylolethane (TME) and trimethylolpropane (TMP). The short-chain triol is added to the composition in order to improve characteristics such as creep and stress relaxation. Two or more of the short-chain triols (tri-functional cross-linking agent) may each be mixed.

The tri-functional cross-linking agent content (molar ratio) of the cross-linking agent is preferably 0 to 0.6, and more preferably 0.05 to 0.4.

Notably, the bi-functional cross-linking agent such as a diamino compound or a short-chain diol, and the tri-functional cross-linking agent such as a short-chain triol may be used in combination, and two or more bi-functional cross-linking agents, or two or more tri-functional cross-linking agents may be used in combination.

The α value is preferably 0.7 to 1.0. The term “α value” refers to a value calculated by the following equation:

α value=(amount (mol) of functional groups in cross-linking agent)/(amount (mol) of isocyanate groups remaining after reaction between polyol and polyisocyanate). When α value is more than 1.0, functional groups such as hydroxyl groups and diamino groups of the cross-linking agent remain and stain a photoreceptor or a similar member which the cleaning blade abuts, whereas when α value is less than 0.7, cross-linking density may considerably lower, resulting in poor mechanical strength, or may stain a photoreceptor due to a long period of time required for the deactivation of remaining isocyanate groups.

The aforementioned components including a polyol, a polyisocyanate, and a diamino compound are mixed, and the mixture is allowed to react, whereby polyurethane is produced. Through controlling the amounts of polyisocyanate and the cross-linking agent, and the balance of the cross-linking agent, etc., the formed cleaning blade member exhibits excellent mechanical characteristics.

In the production of polyurethane members, any conventional polyurethane production method such as the prepolymer method or the one-shot method may be employed. The prepolymer method is suitable in the present invention, since a polyurethane having excellent mechanical strength and wear resistance can be produced. However, no particular limitation is imposed on the production method.

In the polyurethane member of the present invention, the ΔRb (%) is preferably controlled to 40 or less, more preferably 25 or less, through appropriately controlling relative amounts of the polyol, polyisocyanate, diamino compound, and other components, ΔRb being represented by the following formula:

ΔRb (%)=Rb_{T50}−Rb_{T10}

wherein Rb_{T10} and Rb_{T50} represent rebound resilience at 10° C. and that at 50° C., respectively.

When the above conditions are satisfied, the formed cleaning blade member exhibits small variation in physical properties with temperature and sufficiently reliable cleaning performance against changes in the environment.

Preferably, the polyurethane member exhibits an elongation at break of 300% or more. When the elongation is less than 300%, the polyurethane member (cleaning blade member) exhibits poor wear resistance, readily resulting in chipping.

The polyurethane member preferably exhibits a tan δ (1 Hz) peak temperature of 10° C. or lower. When the peak temperature is 10° C. or lower, rubber properties can be maintained under a low-temperature and low-moisture circumstance, and a chipping-resistant cleaning blade member is provided.

The polyurethane member of the present invention preferably has a hardness (JIS A) of 60 to 95°. When the hardness falls within the range, satisfactory cleaning performance can be attained.

Through employment of the aforementioned polyurethane member, the cleaning blade member of the present invention exhibits remarkably small variation in rebound resilience with temperature while the cleaning blade has a comparatively high hardness and maintains mechanical characteristics. Therefore, the cleaning blade of the invention can exhibit consistent cleaning performance also at low temperature.

### EXAMPLES

The present invention will next be described in detail by way of examples.

### Example 1

Caprolactone (PCL) (molecular weight: 2,000) (100 parts (unless otherwise specified, the unit “part(s)” is on the basis weight)) and 3,3-dimethylphenyl-4,4-diisocyanate (TODI) (35 parts) were mixed. 3,5-Dimethylthio-2,4-toluenediamine (DMTDA) and trimethylolpropane (TMP), serving as cross-linking agents, were added to the mixture such that the α value and tri-functional cross-linking agent content (molar ratio) of the cross-linking agent were adjusted to 0.95 and 0.2, respectively. The mixture was allowed to react, to thereby form a polyurethane. The formed polyurethane solid was cut to provide test samples and test cleaning blades of Example 1.

### Example 2

Caprolactone (PCL) (molecular weight: 2,000) (100 parts) and the mixture of MDI and TODI (0.4:0.6 in a weight ratio) (40 parts) were mixed. 3,5-Dimethylthio-2,4-toluenediamine (DMTDA) and TMP, serving as cross-linking agents, were added to the mixture such that the α value and tri-functional cross-linking agent content (molar ratio) of the cross-linking agent were adjusted to 0.95 and 0.4, respectively. The mixture was allowed to react, to thereby form a polyurethane. The formed polyurethane solid was cut to provide test samples and cleaning blades of Example 2.

### Example 3

The procedure of Example 2 was repeated, except that the mixture of MDI and TODI (0.5:0.5 in a weight ratio) (35 parts) were used, and 3,5-dimethylthio-2,4-toluenediamine (DMTDA) and TMP, serving as cross-linking agents, were added to the mixture such that the α value and tri-functional cross-linking agent content (molar ratio) of the cross-linking agent were adjusted to 0.95 and 0.2, respectively, to thereby provide test samples and test cleaning blades of Example 3.

### Example 4

The procedure of Example 2 was repeated, except that the mixture of MDI and TODI (0.7:0.3 in a weight ratio) (35 parts) were used, and 3,5-dimethylthio-2,4-toluenediamine and TMP, serving as cross-linking agents, were added to the mixture such that the α value and tri-functional cross-linking agent content (molar ratio) of the cross-linking agent were adjusted to 0.95 and 0.2, respectively, to thereby provide test samples and test cleaning blades of Example 4.

### Comparative Example 1

The procedure of Example 2 was repeated, except that the mixture of MDI and TODI (0.8:0.2 in a weight ratio) (35 parts) were used, and 3,5-dimethylthio-2,4-toluenediamine (DMTDA) and TMP, serving as cross-linking agents, were added to the mixture such that the α value and tri-functional cross-linking agent content (molar ratio) of the cross-linking agent were adjusted to 0.95 and 0.2, respectively, to thereby provide test samples and test cleaning blades of Comparative Example 1.

### Comparative Example 2

The procedure of Example 1 was repeated, except that MDI (35 parts) was used instead of TODI, and 3,5-dimethylthio-2,4-toluenediamine (DMTDA) and TMP, serving as cross-linking agents, were added to the mixture such that the α value and tri-functional cross-linking agent content (molar ratio) of the cross-linking agent were adjusted to 0.95 and 0.2, respectively, to thereby provide test samples and test cleaning blades of Comparative Example 2.

### Comparative Example 3

The procedure of Example 2 was repeated, except that the mixture of MDI and TODI (0.5:0.5 in a weight ratio) (50 parts) were used, and butanediol (BD) and TMP, serving as cross-linking agents, were added to the mixture such that the α value and tri-functional cross-linking agent content (molar ratio) of the cross-linking agent were adjusted to 0.95 and 0.2, respectively, to thereby provide test samples and test cleaning blades of Comparative Example 3.

### Comparative Example 4

The procedure of Example 1 was repeated, except that MDI (60 parts) was used instead of TODI, and BD and TMP, serving as cross-linking agents, were added to the mixture such that the α value and tri-functional cross-linking agent content (molar ratio) of the cross-linking agent were adjusted to 0.95 and 0.2, respectively, to thereby provide test samples and test cleaning blades of Comparative Example 4.

### Comparative Example 5

The procedure of Example 1 was repeated, except that MDI (40 parts) was used instead of TODI, and BD and TMP, serving as cross-linking agents, were added to the mixture such that the α value and tri-functional cross-linking agent content (molar ratio) of the cross-linking agent were adjusted to 0.95 and 0.3, respectively, to thereby provide test samples and test cleaning blades of Comparative Example 5.

### Comparative Example 6

The procedure of Example 1 was repeated, except that MDI (50 parts) was used instead of TODI, and BD and TMP, serving as cross-linking agents, were added to the mixture such that the α value and tri-functional cross-linking agent content (molar ratio) of the cross-linking agent were adjusted to 0.95 and 0.4, respectively, to thereby provide test samples and test cleaning blades of Comparative Example 6.

### Test Example 1

The test samples of the Examples and the Comparative Examples were evaluated in terms of raw material moldability and surface state. The term “surface state” refers to the surface state of a test sample and was evaluated with the ratings “◯” (surface state without any problem) and “X” (problematic surface state). The “raw material moldability” was evaluated with the ratings “◯” (no problem during molding) and “X” (problems during molding).

The physical properties of the test samples of Examples 1 to 4 and Comparative Examples 4 to 6 were determined as follows. Rubber hardness (JIS A) at 25° C. was determined in accordance with JIS K6301. Tensile strength at 100% elongation (100% modulus), tensile strength at 200% elongation (200% modulus), and tensile strength at 300% elongation (300% modulus) were determined in accordance with JIS K6251. Tensile strength and elongation at break were determined in accordance with JIS K6251. Tear strength was determined in accordance with JIS K6252. Young's modulus (25% elongation) was determined in accordance with JIS K6254. Rebound resilience (Rb) at 25° C. was determined by means of a Lubke pendulum rebound resilience tester in accordance with JIS K6301. Rebound resilience (Rb) was determined also at 10° C. to 50° C., whereby temperature dependency thereof was evaluated. Peak temperature of tan δ (1 Hz) was determined by means of a thermal analyzer, EXSTAR 6000DMS viscoelastic spectrometer (product of Seiko Instruments Inc.). The results are shown in Table 1.

TABLE 1

| | | Ex. 1 | Ex. 2 | Ex. 3 | Ex. 4 |
|---|---|---|---|---|---|
| Polyol | | PCL | PCL | PCL | PCL |
| Molecular weight | | 2,000 | 2,000 | 2,000 | 2,000 |
| of polyol | | | | | |
| Polyisocyanate (parts) | | 35 | 40 | 35 | 35 |
| TODI/polyisocyanate | | 1 | 0.6 | 0.5 | 0.3 |
| Diamino compounds | | Used | Used | Used | Used |
| Bi-functional | | — | — | — | — |
| cross-linking agent | | | | | |
| other than diamino | | | | | |
| compounds | | | | | |
| Tri-functional | | TMP | TMP | TMP | TMP |
| cross-linking agent | | | | | |
| α Value | | 0.95 | 0.95 | 0.95 | 0.95 |
| Tri-functional | | 0.2 | 0.4 | 0.2 | 0.2 |
| cross-linking agent | | | | | |
| content of cross-linking | | | | | |
| agent | | | | | |
| Moldability | | ◯ | ◯ | ◯ | ◯ |
| Surface conditions | | ◯ | ◯ | ◯ | ◯ |
| Item | Method | | | | |
| Hardness (°) | JIS K6301 | 92 | 90 | 92 | 93 |
| Rebound | JIS K6301 | 45 | 41 | 43 | 43 |
| resilience | | | | | |
| (%) | | | | | |
| 100% M | JIS K6251 | 7 | 9 | 9 | 11 |
| (MPa) | | | | | |
| 200% M | JIS K6251 | 8 | 13 | 12 | 16 |
| (MPa) | | | | | |
| 300% M | JIS K6251 | 9 | 20 | 19 | 29 |
| (MPa) | | | | | |
| Tensile | JIS K6251 | 60 | 61 | 68 | 76 |
| strength | | | | | |
| (MPa) | | | | | |
| Elongation | JIS K6251 | 650 | 440 | 465 | 400 |
| at break (%) | | | | | |
| Tear strength | JIS K6252 | 89.4 | 110.4 | 117.3 | 130.0 |
| (kN/m) | | | | | |
| Young's | JIS K6254 | 13.7 | 16.6 | 18.8 | 18.8 |
| modulus | | | | | |
| (MPa) | | | | | |
| Rebound | 10° C. | 39 | 34 | 35 | 35 |
| resilience | 20° C. | 41 | 37 | 38 | 38 |
| | 25° C. | 45 | 41 | 43 | 43 |
| | 30° C. | 45 | 41 | 43 | 43 |
| | 40° C. | 45 | 41 | 43 | 44 |
| | 50° C. | 46 | 42 | 44 | 45 |
| | Δ50-10 | 7 | 8 | 9 | 11 |

| tanδ (1 Hz) Peak | −15 | −8 | −7 | −2 |
|---|---|---|---|---|
| temperature (° C.) | | | | |
| | | Comp. | Comp. | Comp. |
| | | Ex. 1 | Ex. 2 | Ex. 3 |
| Polyol | | PCL | PCL | PCL |
| Molecular weight of polyol | | 2,000 | 2,000 | 2,000 |
| Polyisocyanate (parts) | | 35 | 35 | 50 |
| TODI/polyisocyanate | | 0.2 | 0 | 0.5 |
| Diamino compounds | | Used | Used | Not used |
| Bi-functional cross-linking agent | | — | — | BD |
| other than diamino compounds | | | | |
| Tri-functional cross-linking agent | | TMP | TMP | TMP |
| α Value | | 0.95 | 0.95 | 0.95 |
| Tri-functional cross-linking agent | | 0.2 | 0.2 | 0.2 |
| content of cross-linking agent | | | | |
| Moldability | | X | X | ◯ |
| Surface conditions | | — | — | X |
| Item | Method | | | |
| Hardness (°) | JIS K6301 | — | — | — |
| Rebound resilience (%) | JIS K6301 | — | — | — |
| 100% M (MPa) | JIS K6251 | — | — | — |
| 200% M (MPa) | JIS K6251 | — | — | — |
| 300% M (MPa) | JIS K6251 | — | — | — |
| Tensile strength (MPa) | JIS K6251 | — | — | — |
| Elongation at break (%) | JIS K6251 | — | — | — |
| Tear strength (kN/m) | JIS K6252 | — | — | — |
| Young's modulus (MPa) | JIS K6254 | — | — | — |
| Rebound resilience | 10° C. | — | — | — |
| | 20° C. | — | — | — |
| | 25° C. | — | — | — |
| | 30° C. | — | — | — |
| | 40° C. | — | — | — |
| | 50° C. | — | — | — |
| | Δ50-10 | — | — | — |
| tanδ (1 Hz) Peak temperature (° C.) | | — | — | — |
| | | Comp. | Comp. | Comp. |
| | | Ex. 4 | Ex. 5 | Ex. 6 |
| Polyol | | PCL | PCL | PCL |
| Molecular weight of polyol | | 2,000 | 2,000 | 2,000 |
| Polyisocyanate (parts) | | 60 | 40 | 50 |
| TODI/polyisocyanate | | 0 | 0 | 0 |
| Diamino compounds | | Not used | Not used | Not used |
| Bi-functional cross-linking agent | | BD | BD | BD |
| other than diamino compounds | | | | |
| Tri-functional cross-linking agent | | TMP | TMP | TMP |
| α Value | | 0.95 | 0.95 | 0.95 |
| Tri-functional cross-linking agent | | 0.2 | 0.3 | 0.4 |
| content of cross-linking agent | | | | |
| Moldability | | ◯ | ◯ | ◯ |
| Surface conditions | | ◯ | ◯ | ◯ |
| Item | Method | | | |
| Hardness (°) | JIS K6301 | 84 | 67 | 72 |
| Rebound resilience (%) | JIS K6301 | 27 | 51 | 23 |
| 100% M (MPa) | JIS K6251 | 11 | 5 | 4 |
| 200% M (MPa) | JIS K6251 | 21 | 9 | 7 |
| 300% M (MPa) | JIS K6251 | —* | 11 | 14 |
| Tensile strength (MPa) | JIS K6251 | 42 | 26 | 32 |
| Elongation at break (%) | JIS K6251 | 280 | 350 | 320 |
| Tear strength (kN/m) | JIS K6252 | 88.5 | 39.0 | 54.0 |
| Young's modulus (MPa) | JIS K6254 | 13.6 | 6.0 | 7.0 |
| Rebound resilience | 10° C. | 21 | 23 | 16 |
| | 20° C. | 24 | 40 | 19 |
| | 25° C. | 27 | 51 | 23 |
| | 30° C. | 31 | 58 | 29 |
| | 40° C. | 39 | 71 | 42 |
| | 50° C. | 50 | 77 | 55 |
| | Δ50-10 | 29 | 54 | 40 |

| | | | |
|---|---|---|---|
| tanδ (1 Hz) Peak temperature (° C.) | 5 | −6 | 12 |

*Not measurable due to breakage at 280%

All the test samples of Examples 1 to 4 exhibited excellent raw material moldability and surface state, a hardness (JIS A) of 90° or higher, and a rebound resilience of 41% or higher. Consequently, the cleaning blade members falling within the scope of the present invention have high hardness and exhibit high rebound resilience.

In addition all the test samples also exhibited large 100% modulus, 200% modulus, and 300% modulus; an elongation at break of 300% or higher; a high tear strength, and other excellent mechanical strength values. The test samples exhibited considerably small variation in rebound resilience with temperature, and a tan δ (1 Hz) peak temperature of 10° C. or lower. Consequently, the cleaning blade members falling within the scope of the present invention exhibit excellent mechanical characteristics and maintain reliable performance against changes in the environment.

In contrast, in Comparative Examples 1 and 2, a polyurethane composition containing no TODI or containing TODI in an amount lower than the above-specified amount was allowed to react. Therefore, the composition was foamed possible due to excessively high reaction rate, and test samples could not be formed. In Comparative Example 3, although a polyurethane composition containing TODI but no diamino compound could be molded without any problem, spherulites were observed on a surface of a test sample formed through molding.

In Comparative Examples 4 to 6, although polyurethane compositions containing no TODI nor a diamino compound could be molded without any problem and provided test samples each having no surface problem, the produced test samples were unsatisfactory in terms of mechanical strength such as elongation at break or tensile strength, rebound resilience, and tan δ peak temperature. Furthermore, variation in rebound resilience with temperature was large.

### Test Example 2

Each of the cleaning blades of Examples 1 to 4 and Comparative Examples 3 to 6 was adapted in an actual apparatus (product of Fuji Xerox, Docu Center color 400) and pressed against a photoconductor, and the photoconductor was continuously rotated at a circumferential speed of 125 mm/sec for 60 minutes under LL conditions (10° C., 35%), NN conditions (23° C., 55%), or HH conditions (30° C., 85%), while no paper sheet was conveyed. After completion of the operation, the wear condition of an edge portion of the cleaning blade under HH conditions was observed under a laser microscope, and the amount of wear was microscopically determined. The wear was evaluated by average cross-section area of wear portions in accordance with the following ratings: ◯ (<10 μm²), Δ (10 to 20 μm²), and X (≧20 μm²). Generation of squeaky sounds was aurally checked and was evaluated in accordance with the following ratings: ◯ (no squeaky sounds generated) and X (squeaky sounds generated). Each cleaning blade was evaluated in terms of performance of cleaning a photoreceptor with the following ratings: ◯ (excellent cleaning performance) and X (cleaning incomplete). The above tests were performed under the following conditions, and the results are shown in Table 2.

### <Laser Microscopy Conditions>

Microscope: VK-9500 (KEYENCE Corporation), magnification: ×50

Mode: Ultra-depth color profiling

Optical zoom: ×1.0

Measurement pitch: 0.10 μm

Measurement points: 5 points per cleaning blade (i.e., points 20 mm from the respective ends, points 80 mm from the respective ends, and the center point)

TABLE 2

| | | Ex. | EX. | Ex. | Ex. | Comp. | Comp. | Comp. |
|---|---|---|---|---|---|---|---|---|
| | | 1 | 2 | 3 | 4 | Ex. 4 | Ex. 5 | Ex. 6 |
| LL | Squeaky | ◯ | ◯ | ◯ | ◯ | ◯ | ◯ | ◯ |
| condi- | sound | | | | | | | |
| tions | Wear | ◯ | ◯ | ◯ | ◯ | X | ◯ | ◯ |
| | resistance | | | | | | | |
| | Cleaning | ◯ | ◯ | ◯ | ◯ | X | X | X |
| | performance | | | | | | | |
| NN | Squeaky | ◯ | ◯ | ◯ | ◯ | ◯ | ◯ | ◯ |
| condi- | sound | | | | | | | |
| tions | Wear | ◯ | ◯ | ◯ | ◯ | X | ◯ | ◯ |
| | resistance | | | | | | | |
| | Cleaning | ◯ | ◯ | ◯ | ◯ | ◯ | ◯ | ◯ |
| | performance | | | | | | | |
| HH | Squeaky | ◯ | ◯ | ◯ | ◯ | ◯ | X | Δ |
| condi- | sound | | | | | | | |
| tions | Wear | ◯ | ◯ | ◯ | ◯ | X | X | Δ |
| | resistance | | | | | | | |
| | Cleaning | ◯ | ◯ | ◯ | ◯ | X | X | X |
| | performance | | | | | | | |

Under all tested conditions, the cleaning blade members of Examples 1 to 4 did not generate squeaky sound and exhibited excellent wear resistance and cleaning performance.

In contrast, the cleaning blade member of Comparative Example 4 exhibited poor wear resistance under all tested conditions, possibly due to an elongation at break of 300% or less, and no cleaning performance under the LL and HH conditions. The cleaning blade member of Comparative Example 5, which exhibited large variation in rebound resilience with temperature, failed to exhibit cleaning performance under the LL conditions, and generated squeaky sounds and exhibited poor wear resistance and no cleaning performance under the HH conditions. The cleaning blade member of Comparative Example 6, which exhibited a high tan δ (1 Hz) peak temperature, failed to exhibit cleaning performance under the LL conditions, and generated squeaky sounds and exhibited poor wear resistance and no cleaning performance under the HH conditions.

The tests carried out hereinabove have revealed that the cleaning blade member of the present invention exhibits excellent wear resistance and can be suitably employed under any conditions without performance variation with temperature.

What is claimed is:

1. A cleaning blade member formed of a castable polyurethane member produced through hardening and molding a polyurethane composition containing at least a polyol, a polyisocyanate, and a diamino compound, wherein the diamino compound has a melting point of 80° C. or lower, the polyisocyanate is a blend of 4,4′-diphenylmethane diisocyanate (MDI) and 3,3-dimethylphenyl-4,4-diisocyanate (TODI), and the ratio of TODI in the entirety of polyisocyanate is 30 to 100% by weight.

2. A cleaning blade member as described in claim 1, wherein the diamino compound contains no chlorine atom but contains an aromatic ring in the molecular structure thereof and exhibits a reaction rate slower than that of 2,2′,3,3′-tetrachloro-4,4′-diaminodiphenylmethane under given hardening and molding conditions.

3. A cleaning blade member as described in claim 1, wherein the polyurethane member exhibits a ΔRb (%) of 40 or less, ΔRb (%) being represented by the following formula:
ΔRb (%)=Rb_{T50}−Rb_{T10}
wherein Rb_{T10} and Rb_{T50} represent rebound resilience at 10° C. and that at 50° C., respectively.

4. A cleaning blade member as described in claim 1, wherein the polyurethane member exhibits an elongation at break of 300% or more.

5. A cleaning blade member as described in claim 1, wherein the polyurethane member exhibits a tan δ (1 Hz) peak temperature of 10° C. or lower.
